(19) United States
(12) Patent Application Publication
(10) Pub. No.: US 2024/0049726 A1
(43) Pub. Date: Feb. 15, 2024

(54) FERMENTED COMPOSITION FOR PLANT GROWTH

(71) Applicants: HIROSHIMA UNIVERSITY, Hiroshima (JP); Manda Fermentation Co., Ltd., Hiroshima (JP)

(72) Inventors: Junichi KATO, Hiroshima (JP); Akiko YANO, Hiroshima (JP); SHINSUKE KISHIDA, Hiroshima (JP); KOTARO FUJIOKA, Hiroshima (JP); Hideto TORII, Hiroshima (JP)

(73) Assignees: HIROSHIMA UNIVERSITY, Hiroshima (JP); Manda Fermentation Co., Ltd., Hiroshima (JP)

(21) Appl. No.: 18/271,235

(22) PCT Filed: Feb. 1, 2022
(86) PCT No.: PCT/JP2022/003720

§ 371 Date: Jul. 7, 2023

(30) Foreign Application Priority Data
Feb. 4, 2021 (JP) 2021-016962

(51) Int. Cl. A01N 65/00; A01P 1/00

(52) U.S. Cl. CPC A01N 65/00; A01P 1/00

(57) ABSTRACT

A plant vitality adjuvant for suppressing bacterial wilt disease of plants is provided, the plant vitality adjuvant containing, as a main raw material, a fermented composition obtained by fermenting and aging a plurality of items belonging to fruits, citrus fruits, burdock and carrot belonging to edible roots, grains, sesames, seaweed, and saccharides.

### TECHNICAL FIELD

The present invention relates to a plant vitality adjuvant for suppressing bacterial wilt disease of plants containing a fermented composition as a main raw material.

### BACKGROUND ART

Bacterial wilt disease is a disease that infects and kills more than 200 species of plants, mainly solanaceous plants such as tomatoes, and causes great damage to agriculture. Plants affected by bacterial wilt are characterized by rapidly withering and dying while the plant remains green.

Plants infected with bacterial wilt disease are characterized in that bacterial sludge is found in cut stems in the part near the ground. This bacterial sludge is a bacterial pathogen, Ralstonia solanacearum, and extracellular polysaccharides mass-produced by the Ralstonia solanacearum. The Ralstonia solanacearum grows in a vascular bundle of a plant, and a large number of extracellular polysaccharides deteriorate water passage of the vascular bundle, causing wilting and death.

In the soil where bacterial wilt disease has occurred, the Ralstonia solanacearum survives in the ground and reappears when a suitable host plant is planted. A current countermeasure is a method of grafting to a resistant cultivar, but grafting takes time, efforts, and costs. In addition, crops such as tomatoes and eggplants are easily damaged by bacterial wilt disease, and it is difficult to achieve both good taste and resistance to bacterial wilt disease. So, appropriate countermeasures are hard to find.

As a conventional technique, an inhibitor for Ralstonia solanacearum-related pathological condition containing bacteria belonging to the genus Tepidibacter is disclosed (JP 2020-19755 A (Inhibitor for Ralstonia solanacearum-related pathological condition, method of inhibiting Ralstonia solanacearum-related pathological condition, and use thereof)). In addition, a rootstock for controlling a soil disease of Solanaceae plants, a rootstock being pepino (Solanum muricatum), and a method for controlling a soil disease of Solanaceae plants, the method including grafting pepino (Solanum muricatum) as a rootstock and a Solanaceae plant (except for pepino) as a scion is disclosed. According to the invention, it has also been reported that soil diseases can be easily controlled without using agricultural chemicals because a soil disease control ability provided by pepino can be imparted to a Solanaceae plant grafted as a scion (JP 2017-169555 A (Pepino rootstock grafted tomato, method for making pepino rootstock grafted tomato, and soil disease control method of tomato).

### SUMMARY OF INVENTION

### Technical Problem

However, dissemination of grafting is hardly achieved as grafting takes time, efforts, and costs. Moreover, handling of microbial preparations is difficult. Further, these measures against bacterial wilt disease might affect the taste of crops.

The inventors found out that the bacterial wilt disease is inhibited when a fermented composition according to the present invention is administered to a plant through repeated tests and experiments, and reached the present invention.

### Solution to Problem

Technical means used in the present invention to solve the technical problems are as follows.

The present invention provides a plant vitality adjuvant for suppressing bacterial wilt disease of plants, the plant vitality adjuvant containing, as a main raw material, a fermented composition obtained by fermenting and aging one or more fruits selected from apples, persimmons, bananas, pineapples, akebia, silvervine, figs, wild strawberries, strawberries, wild vines, grapes, wax myrtle, peaches, Ume (Japanese apricots), blueberries, and raspberries, one or more citrus fruits selected from navel oranges, Hassaku oranges, mandarin oranges, sour oranges, oranges, Iyokan oranges, kumquats, Yuzu (citrons), Kabosu oranges, shaddocks, Ponkan oranges, lemons, and limes, one or more edible roots selected from burdock, carrots, garlic, lotus root, and lily bulbs, one or more grains selected from brown rice, glutinous rice, rice, millet, corn, wheat, barley, foxtail millet, and Sawa millet, one or more beans and sesames selected from soybeans, black soybeans, black sesame, white sesame, Azuki beans, and walnuts, one or more types of seaweed selected from Konbu, Wakame, Hijiki, Aonori (laver), and Kawanori (laver), one or more saccharides selected from black sugar, fructose, and glucose, and one or more items selected from honey, starch, cucumbers, Perilla, and celery.

The fermented composition may provide a plant vitality adjuvant for suppressing bacterial wilt disease of plants, the plant vitality adjuvant containing, as a main raw material, a fermented composition containing the following components and amino acid composition, per 100 g of a main component: water: 5.0 g to 50.0 g, protein: 0.5 g to 10.0 g, lipids: 0.05 g to 10.00 g, carbohydrate (glucide): 30.0 g to 75.0 g, carbohydrate (fiber): 0.1 g to 5.0 g, ash: 0.5 g to 5.0 g, β-carotene: 10 μg to 150 μg, Vitamin A potency: 10 IU to 100 IU, Vitamin B1: 0.01 mg to 0.50 mg, Vitamin B2: 0.01 mg to 0.50 mg, Vitamin B6: 0.01 mg to 0.50 mg, Vitamin E: 10.0 mg or less, niacin: 0.1 mg to 6.0 mg, calcium: 50 mg to 900 mg, phosphorus: 200 mg or less, iron: 1.0 mg to 5.0 mg, sodium: 20 mg to 300 mg, potassium: 300 mg to 1000 mg, magnesium: 40 mg to 200 mg, salt equivalent: 0.05 g to 1.00 g, copper: 7.0 ppm or less, for amino acid composition, in 100 g: isoleucine: 30 to 200 mg, leucine: 50 to 400 mg, lysine: 20 to 200 mg, methionine: 10 to 150 mg, cystine: 10 to 100 mg, phenylalanine: 30 to 250 mg, tyrosine: 20 to 200 mg, threonine: 40 to 200 mg, tryptophan: 1 to 100 mg, valine: 30 to 300 mg, histidine: 10 to 200 mg, arginine: 40 to 400 mg, alanine: 50 to 300 mg, aspartic acid: 100 to 600 mg, glutamic acid: 100 to 1200 mg, glycine: 30 to 300 mg, proline: 40 to 400 mg, serine: 30 to 300 mg.

Provided is a plant vitality adjuvant for suppressing bacterial wilt disease, the plant vitality adjuvant containing the fermented composition as a main raw material.

Provided is a plant vitality adjuvant for suppressing bacterial wilt disease and promoting growth of a plant containing the fermented composition as a main raw material. Here, the plant may be the one cultivated in sand, soil or hydroponic culture, or may be a Solanaceae plant.

Moreover, the plant vitality adjuvant may suppress transcription of one or more genes among ralA (ralfuranone biosynthetic enzyme gene), egl (β-1,4-endoglucanase gene), cbhA (cellobiohydrolase A gene), tssB, tssM, vgrG, and hcp among genes of Ralstonia solanacearum. The plant vitality adjuvant may be used as a transcription inhibitor of these genes as well.

Further, provided is a method for suppressing bacterial wilt disease of plants by administering the plant vitality adjuvant containing the fermented composition as a main raw material.

Hereinafter, the present invention will be further described by combining the accompanying drawings and examples.

### BRIEF DESCRIPTION OF DRAWINGS

FIG. 1 is a graph showing disease symptom course of tomato seedlings treated with a diluted solution of Manda No. 31 or distilled water for two days after inoculation of Ralstonia solanacearum.

FIG. 2 is a graph showing inhibitory effects on bacterial wilt disease in a sand culture system in which a PNS medium containing 0.5% Manda No. 31 of which pH was unadjusted and pH was adjusted to 6 has been added.

FIG. 3 is a graph showing viable cell counts of Ralstonia solanacearum in culture in RSM liquid media containing and not containing 0.5% Manda No. 31.

FIG. 4 is a graph showing gene transcription control in Ralstonia solanacearum cells cultured in CPG liquid media containing and not containing 0.5% Manda No. 31.

### DESCRIPTION OF EMBODIMENTS

Hereinafter, embodiments of the present invention will be described based on the drawings. The following description is merely exemplary in nature and is not intended to limit the present invention, its application method, or its use.

The present invention is a method for controlling bacterial wilt disease using a fermented composition.

Examples for showing effectiveness as a method for controlling bacterial wilt disease according to the present invention and tests referring to the mechanism of action thereof will be described.

As the plant, tomato of Solanaceae which is a host of the Ralstonia solanacearum (Ogata-fukuju) was used. Tomato seeds sterilized with hypochlorous acid and Tween 20 were sown on a moistened filter paper, and germinated. Thereafter, the tomato seeds were transplanted to pots containing culture soil mixed with peat moss, and grown in an artificial weather apparatus (28° C., 16 hours during day/8 hours at night).

Manda No. 31 was diluted with distilled water to obtain 0.5, 0.25, and 0.1% (w/v) (250, 500, 1250-fold dilution equivalent, respectively). Ten days after sowing, the tomato seedling together with the pot was immersed in a diluted solution of Manda No. 31 or distilled water, and the root was completely immersed in a treatment solution. After holding in the artificial weather apparatus for additional two days, the pot was pulled up from each treatment solution, and the roots were partially cut by stabbing the four corners of the soil around the seedlings with a knife.

In this test, Manda No. 31 was used as a fermented composition of the present invention. Manda No. 31 is a product made of raw materials large fruits (apple, persimmon, banana, pineapple), small fruits (strawberry, grape, wax myrtle, Ume (Japanese apricots), citrus fruits (navel orange, Hassaku orange, mandarin orange, sour orange, Iyokan orange, and the like), edible roots (burdock, carrot, garlic, lotus root), grains (brown rice, glutinous rice, rice, millet, corn, and the like), beans and sesames (soybean, black soybean, black sesame, white sesame), seaweeds (Konbu, Wakame, Hijiki, and the like), saccharides (black sugar), and others (honey), fermenting and aging them while controlling the temperature for 3 years or more, filtering them, and inspecting and packaging them. The fermented composition of the present invention is not limited to Manda No. 31 (special fertilizer).

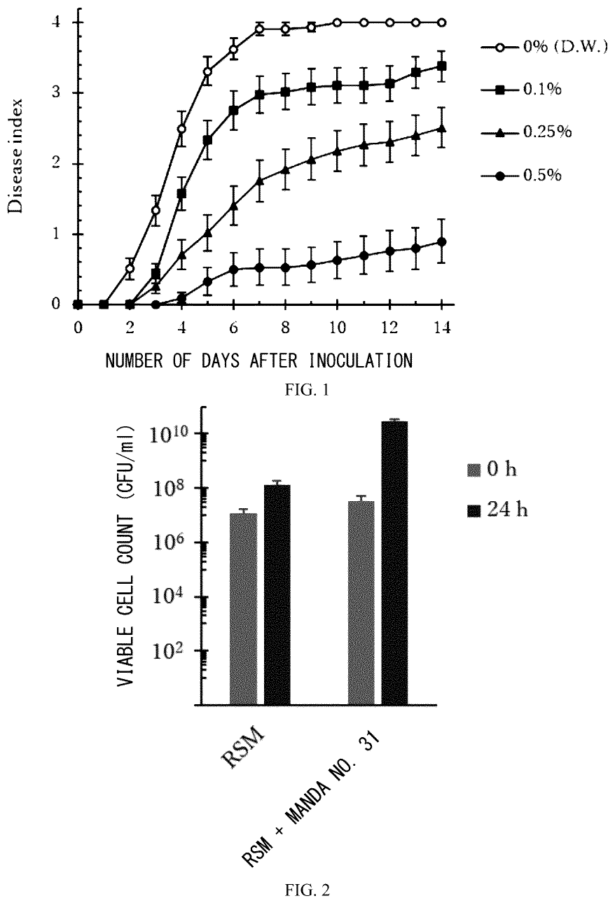

Ralstonia pseudosolanacearum MAFF 106611 was used as a Ralstonia solanacearum strain. A Ralstonia solanacearum strain grown to an OD600 of 0.5 in a liquid medium was washed with sterilized water, then adjusted to an OD600 of 0.3, and 1 mL of the bacterial suspension was inoculated into soil near the root of a tomato seedling with deliberately damaged root. The inoculated seedlings were kept in an artificial weather apparatus for additional 14 days, and disease symptoms were observed daily. Disease symptoms were evaluated with Disease index (0: no symptom/1: 1 to 25% wilt/2: 26 to 50% wilt/3: 51 to 75% wilt/4: 76 to 100% wilt or death). The results are shown in FIG. 1.

As shown in FIG. 1, in the control treated with distilled water, disease symptoms were observed from the second day after inoculation, and on the seventh day, almost all the tested seedlings were confirmed completely wilted or dead. On the other hand, it was shown that in the seedlings treated with a 0.5% diluted solution of Manda No. 31, the disease symptoms were slightly observed from the fourth day after inoculation, but the disease symptoms were significantly suppressed as compared with the control even after the lapse of 14 days. In addition, it was also shown that the inhibitory effect on bacterial wilt disease in Manda No. 31 is concentration-dependent.

A test was conducted to investigate whether the antibacterial effect of Manda No. 31 might be responsible for the bacterial wilt disease control effect. A Ralstonia solanacearum strain R. pseudosolanacearum MAFF 106611 that had been shake cultured overnight in a R. solanacearum minimal (RSM) liquid medium (1.75 g/L K2HPO4, 0.75 g/L KH2PO4, 0.15 g/L trisodium citrate dihydrate, 1.25 g/L (NH4)2SO4, 0.25 g/L MgSO4·7H2O, 5 g/L glucose, pH 7) was passaged to RSM liquid media containing and not containing 0.5% Manda No. 31, respectively, to obtain an OD600 of 0.001, and the bacterial strain was shake-cultured at 28° C., 120 rpm. Culture solutions at the start of culture and after 24 hours were collected respectively to measure the viable cells count (CFU/ml) based on a dilution plate method. The results are shown in FIG. 2.

As shown in FIG. 2, the medium containing 0.5% Manda No. 31 has a significantly higher viable cell count after 24 hours of culture than the medium containing no Manda No. 31. From these results, it was shown that 0.5% Manda No. 31 has no bactericidal effect against the bacterial wilt, but rather acts as a substrate to promote growth.

Due to a buffering capacity of RSM medium used in this test, the pH was 7 when 0.5% Manda No. 31 was added. But in the bacterial wilt disease suppression test, the pH rate of the 0.5% diluted solution of Manda No. 31 prepared with distilled water is about 4.4, which is weakly acidic. The pH rate suitable for growing Ralstonia solanacearum is 6 to 7, and weakly acidic 0.5% Manda No. 31 dilution is considered to have a certain extent of growth inhibiting effect.

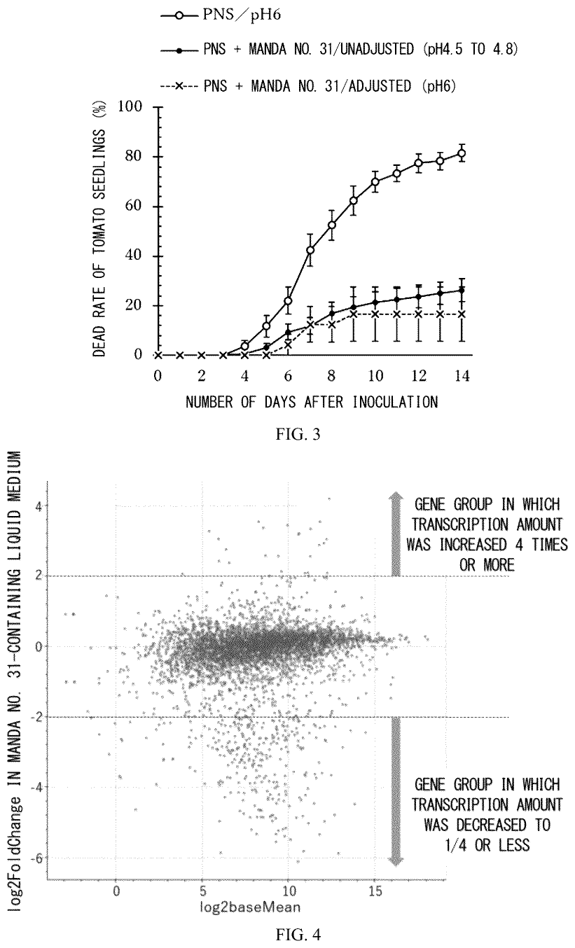

However, in FIG. 3, it was confirmed that Manda No. 31 adjusted to pH 6 also exhibited an equivalent inhibitory effect on bacterial wilt disease to that of the unadjusted one. Therefore, it has become clear that the Ralstonia solanacearum inhibitory effect of Manda No. 31 does not derive from the antibacterial activity.

The test method is described as follows as it is a different method from the above examples. A glass test tube (φ 40 mm) filled with 50 g of silica sand was sterilized in an autoclave (121° C., 20 min), and then a sterilized plant cultivation medium Plant Nutrient Solution (PNS) (0.295 g/L Ca(NO3)2·4H2O, 0.126 g/L KNO3, 0.123 g/L MgSO4·7H2O, 0.136 g/L KH2PO4, and 12 mL of micronutrients (4.6 mg/L Fe [as FeE DTA], 0.5 mg/L B, 0.05 mg/L Zn, 0.02 mg/L Cu, 0.01 mg/L Mo) were added thereto was used as a culture system. The sterilized tomato seeds were sown on a PNS agar medium and grown for 7 days in a artificial weather apparatus, and then the roots were cut at a point about 1 cm away from the stems and planted in a sand culture system.

Ralstonia solanacearum, R. pseudosolanacearum MAFF106611, that had been shake-cultured overnight in a liquid medium, was washed, adjusted to OD600=0.001, and 50 μL of the bacterial suspension was dropped at a point about 3 cm away from the tomato seedling. The inoculated seedlings were kept and observed in an artificial weather apparatus for 14 days. In this test, 8 seedlings were tested at one time in order to calculate the ratio of dead seedlings (FIG. 3).

A test was conducted to investigate whether the inhibitory effect on bacterial wilt disease of Manda No. 31 might be responsible for the inhibition of expression of the pathogenicity-related genes of the Ralstonia solanacearum. Ralstonia solanacearum, R. pseudosolanacearum MAFF 106611, that had been cultured overnight in a CPG (1 g/L casamino acid, 10 g/L high polypeptone, 5 g/L glucose) liquid medium was passaged in a CPG liquid medium containing and not containing 0.5% Manda No. 31 at an OD600 of 0.01, and cultured at 28° C. for about 10 hours. Ralstonia solanacearum cells were collected from the culture solution in the vicinity of OD600 of 0.5, and RNA was extracted using NucleoS pin RNA (MACHEREY-NAGEL). The extracted samples were subjected to RNA-seq, and the obtained data was analyzed using the database of R. solanacearum OE1-1 as a reference (DNAFORM entrusted analysis) to compare the influence of Manda No. 31 on the transcription of each gene.

As a result, as shown in FIG. 4, in the medium to which Manda No. 31 was added, a significant increase in the transcription amount of 4 times or more (log 2FoldChange≥2) was observed for 25 genes, and a significant decrease in the transcription amount of ¼ or less (log 2FoldChange≤2) was observed for 290 genes, as compared with the medium to which Manda No. 31 was not added. As described above, there were more genes whose expression was significantly decreased, and many of them were found to contribute to pathogenicity. Examples thereof include genes involved in extracellular polysaccharide production (xpsR, epsA-F), genes encoding a cell wall degrading enzyme (egl, cbhA), genes encoding a constituent factor of a type VI secretion apparatus (tssB, tssC, tssM, vgrG, hcp), and genes involved in ralfuranone biosynthesis (ralA).

From the above results, the fermented composition (Manda No. 31) of the present invention significantly suppresses bacterial wilt disease, and the effect is not due to a simple antibacterial activity, but the inhibition of expression of genes involved in the pathogenicity of Ralstonia solanacearum.

1. A plant vitality adjuvant for suppressing a bacterial wilt disease of a plant, comprising a fermented composition as a main raw material, wherein the fermented composition is obtained by fermenting and aging one or more fruits selected from apples, persimmons, bananas, pineapples, akebia, silvervine, figs, wild strawberries, strawberries, wild vines, grapes, wax myrtle, peaches, Ume (Japanese apricots), blueberries, and raspberries, one or more citrus fruits selected from navel oranges, Hassaku oranges, mandarin oranges, sour oranges, oranges, Iyokan oranges, kumquats, Yuzu (citrons), Kabosu oranges, shaddocks, Ponkan oranges, lemons, and limes, one or more edible roots selected from burdock, carrots, garlic, lotus root, and lily bulbs, one or more grains selected from brown rice, glutinous rice, rice, millet, corn, wheat, barley, foxtail millet, and Sawa millet, one or more beans and sesames selected from soybeans, black soybeans, black sesame, white sesame, Azuki beans, and walnuts, one or more types of seaweed selected from Konbu, Wakame, Hijiki, Aonori (laver), and Kawanori (laver), one or more saccharides selected from black sugar, fructose, and glucose, and one or more items selected from honey, starch, cucumbers, Perilla, and celery.

2. The plant vitality adjuvant according to claim 1, wherein the fermented composition comprises the following components per 100 g of a main component:
5.0 g to 50.0 g of water,
0.5 g to 10.0 g of a protein,
0.05 g to 10.00 g of lipids,
30.0 g to 75.0 g of carbohydrate (glucide),
0.1 g to 5.0 g of carbohydrate (fiber),
0.5 g to 5.0 g of an ash,
10 μg to 150 μg of β-carotene,
10 IU to 100 IU of a vitamin A potency,
0.01 mg to 0.50 mg of vitamin B1,
0.01 mg to 0.50 mg of vitamin B2,
0.01 mg to 0.50 mg of vitamin B6,
10.0 mg or less of vitamin E,
0.1 mg to 6.0 mg of niacin,
50 mg to 900 mg of calcium,
200 mg or less of phosphorus,
1.0 mg to 5.0 mg of iron,
20 mg to 300 mg of sodium,
300 mg to 1000 mg of potassium,
40 mg to 200 mg of magnesium,
0.05 g to 1.00 g of a salt equivalent, and
7.0 ppm or less of copper,
the fermented composition further comprises an amino acid composition having the following components per 100 g of the main component:
30 to 200 mg of isoleucine,
50 to 400 mg of leucine,
20 to 200 mg of lysine,
10 to 150 mg of methionine,
10 to 100 mg of cystine,
30 to 250 mg of phenylalanine,
20 to 200 mg of tyrosine,
40 to 200 mg of threonine,
1 to 100 mg of tryptophan,
30 to 300 mg of valine,
10 to 200 mg of histidine,
40 to 400 mg of arginine,
50 to 300 mg of alanine,
100 to 600 mg of aspartic acid,
100 to 1200 mg of glutamic acid,
30 to 300 mg of glycine,
40 to 400 mg of proline, and
30 to 300 mg of serine.

3. The plant vitality adjuvant according to claim 1, wherein the plant vitality adjuvant is configured to suppress the bacterial wilt disease in the plant.

4. The plant vitality adjuvant according to claim 1, wherein the plant vitality adjuvant is configured to suppress the bacterial wilt disease in the plant and promote a growth of the plant.

5. The plant vitality adjuvant according to claim 1, wherein the plant vitality adjuvant is configured to suppress the bacterial wilt disease in the plant organism cultivated in sand or soil or hydroponic culture, and promote a growth of the plant the plant is cultivated in a sand or a soil or a hydroponic culture.

6. The plant vitality adjuvant according to claim 1, wherein the plant is a plant selected from Solanaceae, Compositae, Leguminosae, Cruciferae, Cucurbitaceae, Rosaceae, Musaceae, Labiatae, Linaceae, Camelidae, Malvaceae, Euphorbiaceae, Zingiberaceae, Plumbaginaceae, Umbelliferae, Balsaminaceae, Gentianaceae, Crassulaceae, Ranunculaceae, and Portulacaceae, and the plant is infected with the bacterial wilt disease.

7. The plant vitality adjuvant according to claim 1, wherein the plant vitality adjuvant is configured to suppress a transcription of one or two or more of genes of ralA (ralfuranone biosynthetic enzyme gene), egl (β-1,4-endoglucanase gene), cbhA (cellobiohydrolase A gene), tssB, tssM, vgrG, and hcp among genes of Ralstonia solanacearum is suppressed.

8. A method for suppressing a bacterial wilt disease of a plant by administering a plant vitality adjuvant comprising a fermented composition as a main raw material, wherein the fermented composition is obtained by fermenting and aging one or more fruits selected from apples, persimmons, bananas, pineapples, akebia, silvervine, figs, wild strawberries, strawberries, wild vines, grapes, wax myrtle, peaches, Ume (Japanese apricots), blueberries, and raspberries, one or more citrus fruits selected from navel oranges, Hassaku oranges, mandarin oranges, sour oranges, oranges, Iyokan oranges, kumquats, Yuzu (citrons), Kabosu oranges, shaddocks, Ponkan oranges, lemons, and limes, one or more edible roots selected from burdock, carrots, garlic, lotus root, and lily bulbs, one or more grains selected from brown rice, glutinous rice, rice, millet, corn, wheat, barley, foxtail millet, and Sawa millet, one or more beans and sesames selected from soybeans, black soybeans, black sesame, white sesame, Azuki beans, and walnuts, one or more types of seaweed selected from Konbu, Wakame, Hijiki, Aonori (laver), and Kawanori (laver), one or more saccharides selected from black sugar, fructose, and glucose, and one or more items selected from honey, starch, cucumbers, Perilla, and celery, wherein
the fermented composition comprises the following components per 100 g of a main component:
5.0 g to 50.0 g of water,
0.5 g to 10.0 g of a protein,
0.05 g to 10.00 g of lipids,
30.0 g to 75.0 g of carbohydrate (glucide),
0.1 g to 5.0 g of carbohydrate (fiber),
0.5 g to 5.0 g of an ash,
10 μd to 150 μg of β-carotene,
10 IU to 100 IU of a vitamin A potency,
0.01 mg to 0.50 mg of vitamin B1,
0.01 mg to 0.50 mg of vitamin B2,
0.01 mg to 0.50 mg of vitamin B6,
10.0 mg or less of vitamin E,
0.1 mg to 6.0 mg of niacin,
50 mg to 900 mg of calcium,
200 mg or less of phosphorus,
1.0 mg to 5.0 mg of iron,
20 mg to 300 mg of sodium,
300 mg to 1000 mg of potassium,
40 mg to 200 mg of magnesium,
0.05 g to 1.00 g of a salt equivalent, and
7.0 ppm or less of copper,
the fermented composition further comprises an amino acid composition having the following components per 100 g of the main component:
30 to 200 mg of isoleucine,
50 to 400 mg of leucine,
20 to 200 mg of lysine,
10 to 150 mg of methionine,
10 to 100 mg of cystine,
30 to 250 mg of phenylalanine,
20 to 200 mg of tyrosine,
40 to 200 mg of threonine,
1 to 100 mg of tryptophan,
30 to 300 mg of valine,
10 to 200 mg of histidine,
40 to 400 mg of arginine,
50 to 300 mg of alanine,
100 to 600 mg of aspartic acid,
100 to 1200 mg of glutamic acid,
30 to 300 mg of glycine,
40 to 400 mg of proline, and
30 to 300 mg of serine.

9. The plant vitality adjuvant according to claim 2, wherein the plant vitality adjuvant is configured to suppress the bacterial wilt disease in the plant.

10. The plant vitality adjuvant according to claim 2, wherein the plant vitality adjuvant is configured to suppress the bacterial wilt disease in the plant and promote a growth of the plant.

11. The plant vitality adjuvant according to claim 3, wherein the plant vitality adjuvant is configured to suppress the bacterial wilt disease in the plant and promote a growth of the plant.

12. The plant vitality adjuvant according to claim 2, wherein the plant vitality adjuvant is configured to suppress the bacterial wilt disease in the plant cultivated and promote a growth of the plant, the plant is cultivated in a sand or a soil or a hydroponic culture.

13. The plant vitality adjuvant according to claim 3, wherein the plant vitality adjuvant is configured to suppress the bacterial wilt disease in the plant and promote a growth of the plant, the plant is cultivated in a sand or a soil or a hydroponic culture.

14. The plant vitality adjuvant according to claim 4, wherein the plant vitality adjuvant is configured to suppress the bacterial wilt disease in the plant and promote a growth of the plant, the plant is cultivated in a sand or a soil or a hydroponic culture.

15. The plant vitality adjuvant according to claim 2, wherein the plant is a plant selected from Solanaceae, Compositae, Leguminosae, Cruciferae, Cucurbitaceae, Rosaceae, Musaceae, Labiatae, Linaceae, Camelidae, Malvaceae, Euphorbiaceae, Zingiberaceae, Plumbaginaceae, Umbelliferae, Balsaminaceae, Gentianaceae, Crassulaceae, Ranunculaceae, and Portulacaceae, and the plant is infected with the bacterial wilt disease.

16. The plant vitality adjuvant according to claim 3, wherein the plant is a plant selected from Solanaceae, Compositae, Leguminosae, Cruciferae, Cucurbitaceae, Rosaceae, Musaceae, Labiatae, Linaceae, Camelidae, Malvaceae, Euphorbiaceae, Zingiberaceae, Plumbaginaceae, Umbelliferae, Balsaminaceae, Gentianaceae, Crassulaceae, Ranunculaceae, and Portulacaceae, and the plant is infected with the bacterial wilt disease.

17. The plant vitality adjuvant according to claim 4, wherein the plant is a plant selected from Solanaceae, Compositae, Leguminosae, Cruciferae, Cucurbitaceae, Rosaceae, Musaceae, Labiatae, Linaceae, Camelidae, Malvaceae, Euphorbiaceae, Zingiberaceae, Plumbaginaceae, Umbelliferae, Balsaminaceae, Gentianaceae, Crassulaceae, Ranunculaceae, and Portulacaceae, and the plant is infected with the bacterial wilt disease.

18. The plant vitality adjuvant according to claim 5, wherein the plant is a plant selected from Solanaceae, Compositae, Leguminosae, Cruciferae, Cucurbitaceae, Rosaceae, Musaceae, Labiatae, Linaceae, Camelidae, Malvaceae, Euphorbiaceae, Zingiberaceae, Plumbaginaceae, Umbelliferae, Balsaminaceae, Gentianaceae, Crassulaceae, Ranunculaceae, and Portulacaceae, and the plant is infected with the bacterial wilt disease.

19. The plant vitality adjuvant according to claim 2, wherein the plant vitality adjuvant is configured to suppress a transcription of one or two or more of genes of ralA (ralfuranone biosynthetic enzyme gene), egl (β-1,4-endoglucanase gene), cbhA (cellobiohydrolase A gene), tssB, tssM, vgrG, and hcp among genes of Ralstonia solanacearum.

20. The plant vitality adjuvant according to claim 3, wherein the plant vitality adjuvant is configured to suppress a transcription of one or two or more of genes of ralA (ralfuranone biosynthetic enzyme gene), egl (β-1,4-endoglucanase gene), cbhA (cellobiohydrolase A gene), tssB, tssM, vgrG, and hcp among genes of Ralstonia solanacearum.
